(19) United States
(12) Patent Application Publication
(10) Pub. No.: US 2022/0081146 A1
(43) Pub. Date: Mar. 17, 2022

(54) BIODEGRADABLE LAWN AND LEAF BAG INSERT SYSTEM

(71) Applicant: Charles J. Bugajsky, Peoria, AZ (US)

(72) Inventor: Charles J. Bugajsky, Peoria, AZ (US)

(21) Appl. No.: 16/351,189

(22) Filed: Mar. 12, 2019

(51) Int. Cl. B65B 67/12; B65F 1/00; B65F 1/08; B65F 1/14

(52) U.S. Cl. CPC B65B 67/1205; B65B 67/1238; B65F 1/0006; B65F 2250/108; B65F 1/1415; B65F 2240/138; B65F 2250/105; B65F 1/08

(57) ABSTRACT

A biodegradable lawn and leaf bag support insert configured to fit inside an open and expanded standard-sized lawn and leaf bag, comprising a standard-sized lawn and leaf bag; and a foldable insert configured to fit inside the standard-sized lawn and leaf bag when the foldable insert is fully expanded; wherein the foldable insert forms a rectangular shape with a top edge and a bottom edge, wherein the top edge is configured to be below a top edge of the standard-sized lawn and leaf bag; wherein the foldable insert is constructed from a semi-flexible biodegradable material.

### FIELD OF THE INVENTION

The present invention relates generally to devices for supporting and reinforcing trash bags during filling. More specifically, the present invention relates to a biodegradable insert configured to hold open and reinforce a standard yard lawn and leaf bag during filling and be left inside the bag for composting.

### BACKGROUND OF THE INVENTION

Many townships and municipalities require residents to separate yard lawn and leaf from other trash that is set out for scheduled pick-up by placing the yard lawn and leaf in specially designed yard lawn and leaf bags. These yard lawn and leaf bags typically consist of heavy paper and are generally rectangular in shape, like a large grocery bag.

However, many problems occur when attempting to fill these bags. For example, since the yard lawn and leaf bags are made of paper, there is no support to maintain the bag in an open position other than the heavy paper construction. Additionally, when the person begins filling the bag and attempts to compact the collected yard lawn and leaf, the shape of the bag becomes distorted, causing it to fall over and/or causing any compacted twigs, branches, etc. to tear or rip the bag during filling. If the person wants to avoid this, the user may simply not fill the entire bag, but just obtain a second bag, thereby not getting the full use of the yard lawn and leaf bag which is wasteful.

Although attempts have been made to solve some of the above problems, none of them are designed to have the insert left inside the bag and allowed to biodegrade with the rest of the yard lawn and leaf and the bag itself. Additionally, existing inserts are designed to be removed from the bag after filling, thus allowing sharper debris to punch through the yard lawn and leaf bag during handling and filling.

Designed by a twice wounded combat veteran in the vietnam war to make handling and filling a standard yard lawn and leaf bag easier, the present invention is designed to be placed inside the yard lawn and leaf bag for filling, then left inside the yard lawn and leaf bag for disposal, or even be integrated into the yard lawn and leaf bag to prevent punctures yet still be allowed to biodegrade along with the yard lawn and leaf and bag.

### OBJECTS OF THE INVENTION

Accordingly, it is the general object of this invention to provide a solution to the disadvantages of the prior art.

It is an object of the present invention to provide an insert for facilitating the filling of a yard lawn and leaf bag by adding more rigidity during filling of the yard lawn and leaf bag.

It is still yet another object of the present invention to provide an insert for facilitating the filling of a yard lawn and leaf bag by preventing the ripping and/or tearing of the yard lawn and leaf bag during filling and compacting.

It is still yet another object of the present invention to provide an insert for facilitating the filling of a yard lawn and leaf bag that does not have to be removed yet will biodegrade along with the yard lawn and leaf and bag.

It is still yet another object of the present invention to provide an insert for facilitating the filling of a yard lawn and leaf bag that is an additional reinforcement integrated within the yard lawn and leaf bag construction.

### BRIEF SUMMARY OF THE INVENTION

These and other objects of the instant invention are achieved by providing a biodegradable lawn and leaf bag insert system for facilitating the collection of yard lawn and leaf (dry leaves, twigs, branches, trimmed shrubbery, etc.) into a yard lawn and leaf bag. The biodegradable insert system comprises

### BRIEF DESCRIPTION OF THE DRAWINGS

The particular objects and features of the invention as well as the advantages will become apparent from the following description taken in connection with the accompanying drawings in which:

FIG. 1 is a perspective view of a Biodegradable Lawn and leaf Bag Insert System according to the preferred embodiment of the present invention.

FIG. 2 is a front view of the Biodegradable Lawn and leaf Bag Insert System according to the preferred embodiment of the present invention.

FIG. 3 is a perspective view of the Biodegradable Lawn and leaf Bag Insert System according to the preferred embodiment of the present invention.

FIG. 4 is a perspective view on the Biodegradable Lawn and leaf Bag Insert System according to the preferred embodiment of the present invention.

### DETAILED DESCRIPTION OF THE INVENTION

The foregoing and other objectives, features, and advantages of the invention will be more readily understood upon consideration of the following description of the invention taken in conjunction with the accompanying drawings.

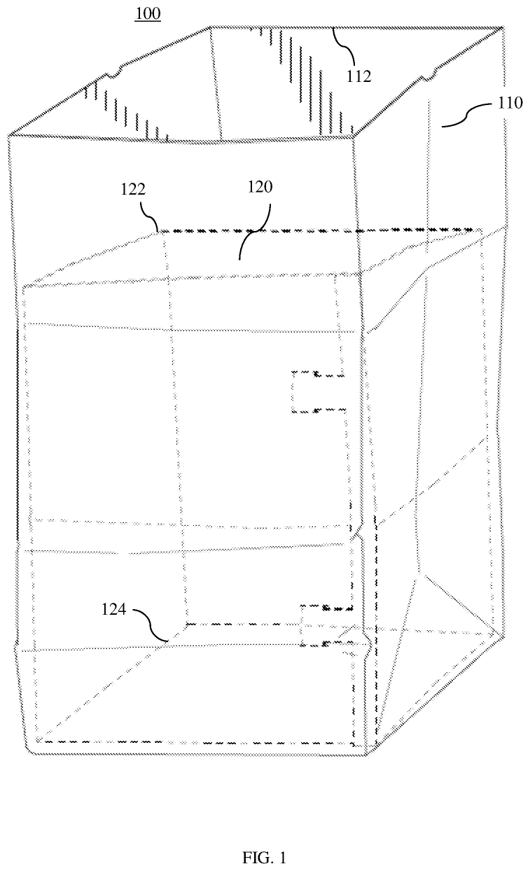

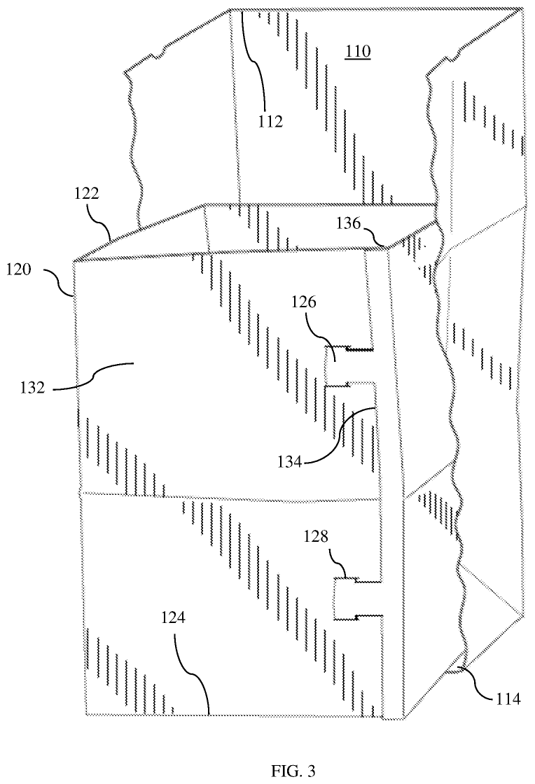

Referring now to the attached drawings, FIGS. 1-4 show the present invention is preferably a biodegradable disposable foldable insert 100 preferably configured to fit inside an open and expanded standard-sized lawn and leaf bag, comprising a foldable insert 120 configured to fit inside a standard lawn and leaf bag 110. The foldable insert 120 is preferably comprises a top edge 122, a bottom edge 124, and a plurality of panels 132. The foldable insert 120 preferably expands to form a rectangular shape configured such that the top edge 122 is below a top edge 112 of the standard lawn and leaf bag 110. The foldable insert 120 is preferably comprised of a semi-flexible biodegradable material.

The foldable insert 120 is preferably configured to be placed inside the standard lawn and leaf bag 110 such that the foldable insert 120 is placed on a bottom surface of the standard lawn and leaf bag. Further, the foldable insert is configured such that when opened, or expanded, the outside surface of the foldable insert mates with an inside surface of the standard lawn and leaf bag 110. The foldable insert 120 top edge is preferably below the standard lawn and leaf bag top edge 112 so that, once full of debris, the standard lawn and leaf bag 110 can be closed without removing the foldable insert 120.

The foldable insert 120 preferably further comprises a plurality of panels 132 foldably connected to each other such that the foldable insert 120 forms a rectangular shape when opened, or expanded, inside the standard lawn and leaf bag 110 and folds down flat prior to use for storage and packaging. In an alternate embodiment, the foldable insert 120 preferably forms a generally circular shape when opened or expanded and placed into the standard lawn and leaf bag (not shown).

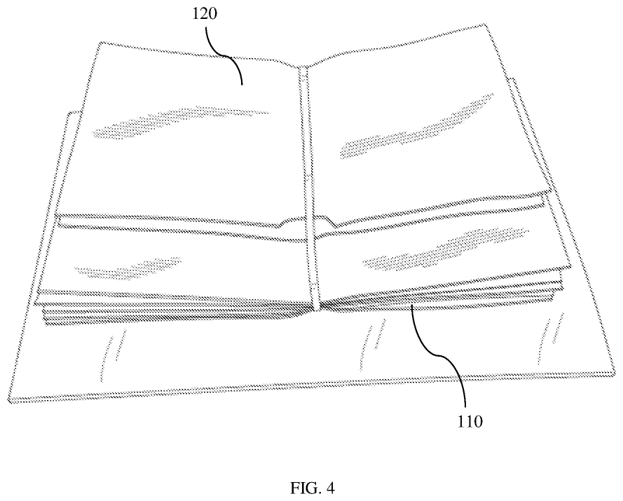

The foldable insert 120 is preferably configured to lay flat and be packaged and sold with the standard lawn and leaf bag 110, as shown in FIG. 4. Alternately preferably, the foldable insert 120 is packaged separately but still in a flat configuration such that a user will open, or expand, the foldable insert 120 and place inside a standard lawn and leaf bag 110.

The foldable insert 120 preferably further comprises at least one tab 126 on a first edge 134 and at least one slot 128 on a second edge 136. Preferably, the at least one tab 126 is configured to fit into the at least one slot 128 such that the first edge 134 is coupled to the second edge 136 forming a rectangular hollow tube. Alternately preferably, the foldable insert 120 is opened such that the first edge 134 is abutted against the second edge 136 to form a relatively rectangular shape. Alternately preferably, the first edge 134 is configured to wrap around the second edge 136 to provide an overlap without tabs or slots when the foldable insert is opened or expanded. Alternately preferably, the overlap further comprises a biodegradable adhesive to adhere a portion of the panel to the overlap.

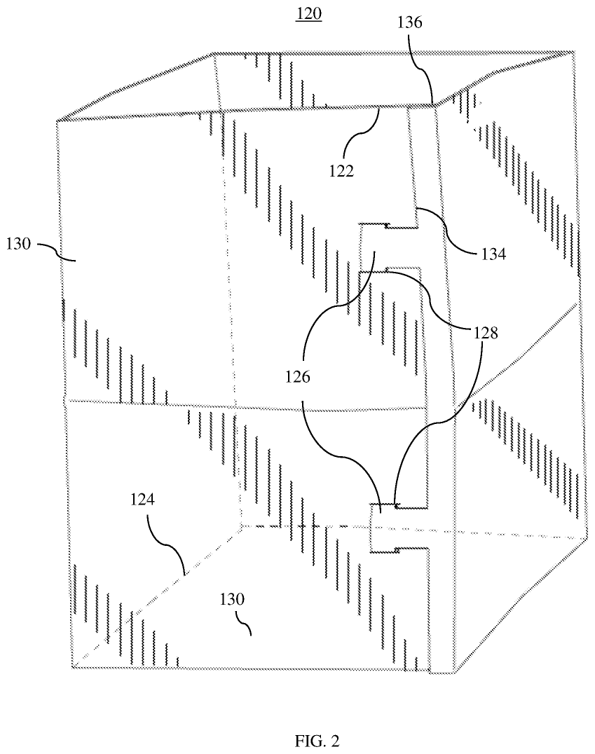

In an alternate embodiment, as shown in FIG. 2, the foldable insert 120 further comprises a bottom flap 130 configured to unfold and cover a bottom surface of the lawn and leaf bag 110 when the foldable insert 120 is expanded inside the standard lawn and leaf bag. In this alternate embodiment, the bottom flap 130 is preferably foldably connected to at least one bottom edge 124 of the foldable insert 120 and is configured to fold against the foldable insert 120 when flat.

In an alternate embodiment, the foldable insert 120 is integrated with the standard lawn and leaf bag 110. In this alternate embodiment, the lawn and leaf bag 110 is constructed with a semi-flexible layer of biodegradable material on the inside of the sidewalls of the lawn and leaf bag. In this alternate embodiment, the foldable insert 120 preferably starts at a bottom surface 114 of the lawn and leaf bag 110 and extends up a distance to stop short of a top edge 112 of the lawn and leaf bag 110.

The foldable insert 120 is preferably comprised of one layer of biodegradable material, such as a paper-based cardboard. In an alternate embodiment, the foldable insert 120 is comprised of multiple layers of biodegradable material. In this alternate embodiment, the multiple layers of biodegradable material can be comprised of the same biodegradable material or different biodegradable materials. In this alternate embodiment, the multiple layers of biodegradable material are preferably bonded together using a biodegradable adhesive material.

The foldable insert 120 is preferably configured to be a rectangular hollow tube shape when opened or expanded. The rectangular hollow tube shape preferably matches the inside structure of the standard yard lawn and leaf bags available all across the country.

Although the present invention has been described by way of example, it should be appreciated that variations and modifications may be made without departing from the scope of the invention. Furthermore, where known equivalents exist to specific features, such equivalents are incorporated as if specifically referred to in this specification.

We claim:

1. A foldable insert configured to fit inside a paper lawn and leaf bag, the foldable insert comprising:
a plurality of panes foldably connected to each other such that the foldable insert forms a rectangular shape having a top edge and a bottom edge when expanded within the paper lawn and leaf bag,
wherein the plurality of panes comprises a plurality of vertical panels and a single bottom flap;
wherein the top edge is disposed below a corresponding top edge of the paper lawn and leaf bag when the foldable insert is expanded inside the paper lawn and leaf bag;
wherein the single bottom flap is configured to cover a bottom surface of the paper lawn and leaf bag and to be positioned perpendicular to the plurality of vertical panels when the foldable insert is expanded,
wherein a first end of the single bottom flap is foldably attached to the bottom edge of a first panel of the plurality of vertical panels at an intersection and an opposite end of the single bottom flap abuts the bottom edge of a second and opposite panel of the plurality of vertical panels,
wherein a distance between the top edge and the bottom edge of the second panel is a same distance as between the top edge and the intersection of the first panel; and
wherein the foldable insert is constructed from a disposable semi-flexible biodegradable material.

2. The foldable insert of claim 1, wherein the rectangular shape is a rectangular hollow tube, and
wherein a first edge of the foldable insert is configured to mate with a second edge of the foldable insert to form the rectangular hollow tube.

3. The foldable insert of claim 2, wherein the foldable insert further comprises at least one tab extending from the first edge and configured to fit into at least one slot on the second edge.

4. (canceled)

5. The foldable insert of claim 1, wherein the foldable insert is integral to the paper lawn and leaf bag.

6. The foldable insert of claim 1, wherein the biodegradable material is a paper-based material.

7. The foldable insert of claim 6, wherein the foldable insert is configured to be a rectangular hollow tube shape.

8. (canceled)

9. The foldable insert of claim 1, wherein the foldable insert further comprises multiple layers of biodegradable material.

10. The foldable insert of claim 9, wherein the multiple layers of biodegradable material further comprise a plurality of different biodegradable materials.

11. A paper lawn and leaf bag insert system comprising:
a paper lawn and leaf bag; and
a foldable insert comprising a plurality of vertical panels and a single bottom flap, the foldable insert configured to fit inside the paper lawn and leaf bag and to form a rectangular shape when expanded;
wherein the foldable insert comprises a first edge configured to mate with a second edge;
wherein the foldable insert comprises a semi-flexible biodegradable material;
wherein the single bottom flap is configured to cover a bottom surface of the paper lawn and leaf bag and to be positioned perpendicular to the plurality of vertical panels when the foldable insert is expanded;
wherein a first end of the single bottom flap is foldably attached to the bottom edge of a first panel of the plurality of vertical panels at an intersection and an opposite end of the single bottom flap abuts the bottom edge of a second and opposite panel of the plurality of vertical panels;
wherein a distance between the top edge and the bottom edge of the second panel is a same distance as between the top edge and the intersection of the first panel; and
wherein a top edge of the foldable insert is disposed below a corresponding top edge of the lawn and leaf bag when the foldable insert is expanded inside the lawn and leaf bag.

12. The insert system of claim 11, wherein the foldable insert comprises at least one tab on the first edge and at least one slot on the second edge, and wherein the at least one tab is configured to fit into the at least one slot.

13. (canceled)

14. The insert system of claim 11, wherein the foldable insert is integral to the paper lawn and leaf bag.

15. The insert system of claim 11, wherein the biodegradable material is a paper-based material.

16. The insert system of claim 11, wherein the rectangular shape is a rectangular hollow tube.

17. (canceled)

18. The insert system of claim 11, wherein the foldable insert comprises multiple layers of biodegradable material.

19. The insert system of claim 18, wherein the multiple layers of biodegradable material comprise a plurality of different biodegradable materials.

20. The foldable insert of claim 2, wherein the first edge is configured to wrap around the second edge to provide an overlap when the foldable insert is in an expanded position.

21. The foldable insert of claim 20, wherein the overlap comprises a biodegradable adhesive to adhere at least one of the plurality of vertical panels to the overlap.

22. The insert system of claim 11, wherein the first edge is configured to wrap around the second edge to provide an overlap when the foldable insert is in an expanded position.

23. The insert system of claim 22, wherein the overlap comprises a biodegradable adhesive to adhere at least one of the plurality of vertical panels to the overlap.
